(19) United States
(12) Patent Application Publication
(10) Pub. No.: US 2023/0370572 A1
(43) Pub. Date: Nov. 16, 2023

(54) SYSTEMS AND METHODS FOR MONITORING OPERATION UNDER LIMP MODE

(71) Applicant: Caterpillar Inc., Peoria, IL (US)

(72) Inventors: Shawn N. Mathew, Savoy, IL (US); Arthur Milkowski, Oro Valley, AZ (US); John M. Plouzek, Peioria, IL (US); Norman Keith Lay, Baden, PA (US); Subhani M. Shaik, Peoria, IL (US)

(21) Appl. No.: 17/742,257

(22) Filed: May 11, 2022

(51) Int. Cl. H04N 7/18; H04N 17/00

(52) U.S. Cl. CPC H04N 7/188; H04N 17/002

(57) ABSTRACT

The present disclosure is directed to systems and methods for operating a machine. The method includes (1) receiving image data of a component of the machine by a camera module of the machine, the camera module having multiple camera components; (2) detecting an incident associated with the camera module; (3) in response to the incident, instructing the camera module to collect image data from a subset of the multiple camera components; and (4) generating a status image of the component based on the collected image data from the subset of the multiple camera components.

### TECHNICAL FIELD

The present technology is directed to systems and methods for monitoring operations of machines, vehicles, or other suitable devices. More particularly, systems and methods for monitoring operations of components of a machine or a vehicle when an incident ((view/scene obstruction, camera dysfunction, etc.) occurs.

### BACKGROUND

Machines are used to perform various operations in different industries, such as construction, mining, and transportation. Visually observing components of these machines during operation provides useful information to monitor the status of the components (e.g., normal, worn, damaged, etc.) so an operator can adjust accordingly. One approach is to use one or more cameras to capture images of these components. However, during operation, there can frequently be view obstruction or blockage, and therefore the image quality of the captured images can be compromised. U.S. Pat. No. 10,587,828 (Ulaganathan) provides systems and methods for generating “distortion free” images by combining multiple completely or partially distorted images into a single image. This approach requires significant computing resources and processing time. Therefore, it is advantageous to have an improved method and system to address the foregoing needs.

### SUMMARY OF THE INVENTION

The present technology is directed to systems and methods for monitoring operations of a machine vehicles, or other suitable devices. During normal operation, multiple cameras can be used to monitor a component (e.g., an excavator bucket). When an incident (e.g., view obstruction or blockage, camera dysfunction, etc.), the present system enables the machine to keep operating under a “limp” mode or a “reduced functionality” mode, where images from an obstructed camera is discard and the system can continue to operate and keep providing images from non-obstructed cameras to an operator. By this arrangement, the operator can keep monitoring the machine under the limp mode without interrupting the ongoing operation, and can plan to address the incident (e.g., clean the obstructed camera, repair, maintenance, etc.) at a later, convenient time.

In some embodiments, these cameras include grayscale lens, color lens, infrared camera, depth camera, etc. In some embodiments, there can be three individual cameras, a left grayscale lens, a right grayscale lens, and a color lens. Embodiments of these cameras and lenses are discussed in detail with reference to FIG. 3.

Using the foregoing three-camera configuration as an example, when the left grayscale lens is occluded by debris, the present system can use images from the right grayscale lens and the color lens and corresponding trained models to provide monitoring information to the operator. By this arrangement, the operator does not need to stop the ongoing task simply because the blockage of the left grayscale lens, and can continues observing until completing the ongoing task. In some embodiments, the system can send an alert to the operator indicating the blockage. The operator can determine whether to operate the machine under the limp mode.

### BRIEF DESCRIPTION OF THE DRAWINGS

Non-limiting and non-exhaustive examples are described with reference to the following figures.

FIG. 1 is a schematic diagram illustrating a method for operating a machine under a limp mode in accordance with embodiments of the present technology.

FIG. 2 is a schematic diagram illustrating components of a machine in accordance with embodiments of the present technology.

FIG. 3 is a schematic diagram illustrating a camera module of a machine in accordance with embodiments of the present technology.

FIG. 4 is a picture showing an image captured by a camera module in accordance with embodiments of the present technology.

FIG. 5 is a schematic diagram illustrating a machine learning or training process in accordance with embodiments of the present technology.

FIG. 6 is a schematic diagram illustrating components in a computing device in accordance with embodiments of the present technology.

FIG. 7 is a flow diagram showing a method in accordance with embodiments of the present technology.

### DETAILED DESCRIPTION

Various aspects of the disclosure are described more fully below with reference to the accompanying drawings, which form a part hereof, and which show specific exemplary aspects. Different aspects of the disclosure may be implemented in many different forms and the scope of protection sought should not be construed as limited to the aspects set forth herein. Rather, these aspects are provided so that this disclosure will be thorough and complete, and will fully convey the scope of the aspects to those skilled in the art. Aspects may be practiced as methods, systems, or devices. Accordingly, aspects may take the form of a hardware implementation, an entirely software implementation, or an implementation combining software and hardware aspects. The following detailed description is, therefore, not to be taken in a limiting sense.

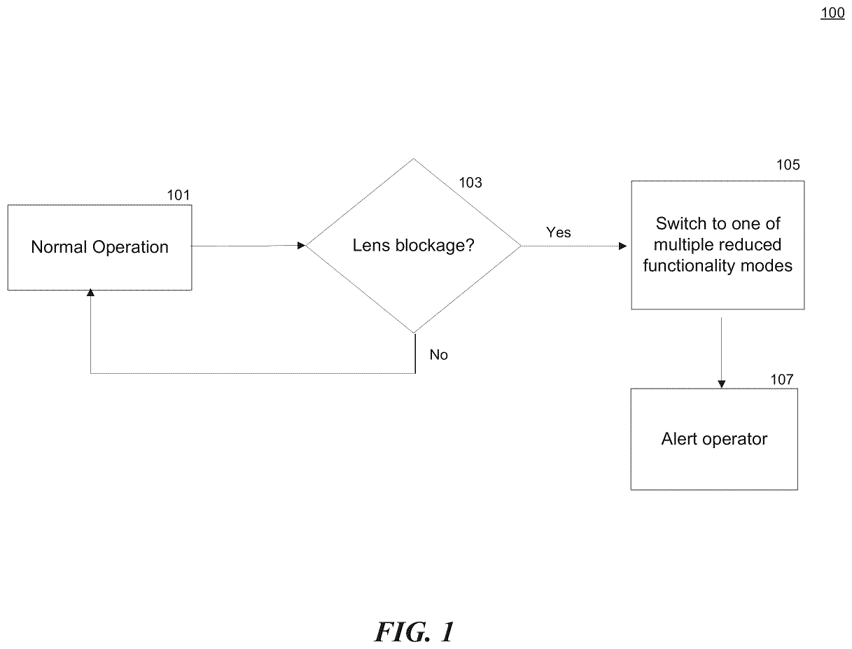

FIG. 1 is a schematic diagram illustrating a method 100 for operating a machine under a limp mode in accordance with embodiments of the present technology. At block 101, the machine is operated under a normal mode with multiple cameras monitoring the machine's operation. If no incident is detected, the method 100 continues operating under the normal mode (block 101). Each of the multiple cameras operates normally (e.g., no view obstruction/blockage, etc.). At block 103, when an incident (e.g., a “lens blockage” as shown in FIG. 1) is detected, the method 100 moves to block 105 to switch from the normal mode to a limp mode or a reduced functionality mode. In some embodiments, there can be multiple limp mode to be selected from.

For example, assuming that there are three cameras A, B, and C are used to monitor the machine under the normal mode. At block 103, a lens blockage of camera A is detected and reported. At block 105, the operation mode is switched a limp mode LM, where only images from cameras B and C are used to generate simulated images for an operator. In some embodiments, there can be fewer or more than three cameras used in the normal mode. In some embodiments, the cameras can include a grayscale lens, a color lens, an infrared camera, a depth camera, etc.

At block 107, the method 100 send an alert or notice to the operator such that the operator can act accordingly. In some embodiments, the alert can include the details of the incident (e.g., camera A is obstructed by debris; 25% of Camera A's viewing area is blocked; dysfunction of camera A is detected, etc.). In some embodiments, a recommendations of further action (e.g., check/clean camera; reduce operation speed, adjust camera angle, schedule maintenance; go to repair station X, etc.) can also be provided. By this arrangement, the method 100 enables the machine to be operated under a limp mode without requiring the operator to stop the current operation due to the incident.

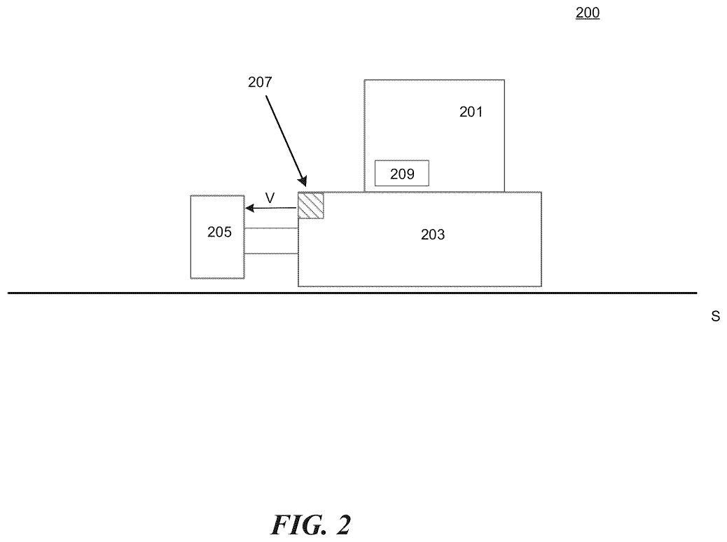

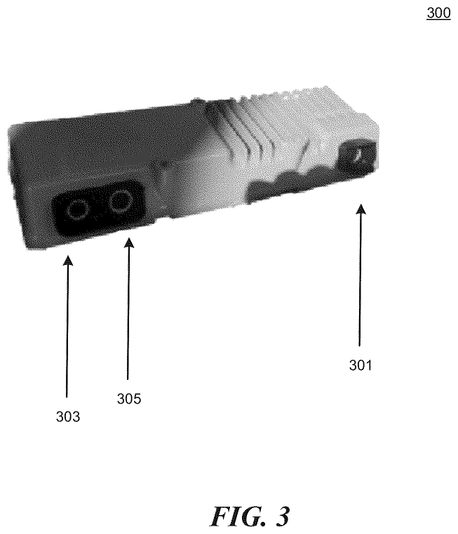

FIG. 2 is a schematic diagram illustrating components of a machine 200 in accordance with embodiments of the present technology. The machine 200 can be operated and travel on surface S. The machine 200 includes a main body 201 (e.g., an operator cabin for an operator to sit in), a driving unit 203 (e.g., an undercarriage to drive the machine 200), a front component 205 (e.g., an excavator bucket), and a camera module 207. The main body 201 can include a processor 209 or controller to control and communicate with the components (including the driving unit 203, the front component 205, and the camera module 207) of the machine 200. Embodiments of the camera module 207 are discussed in detail with reference to FIG. 3. The camera module 207 includes multiple cameras (or lenses).

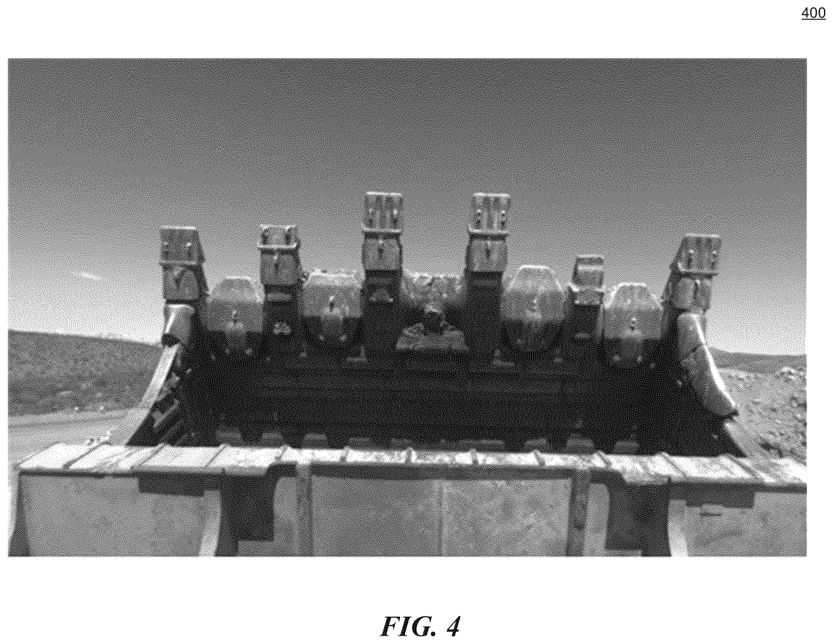

In the illustrated embodiments, the camera module 207 is configured to observe the front component 205 (e.g., in direction V) and monitor the status thereof. For example, the camera module 207 is configured to generate a status image of the front component 207 showing its current status (e.g., whether it is damaged/worn, loading status, etc.). The status image is presented to the operator so the operator can closely monitor the operation of the machine 200. Embodiments of the status image are discussed in detail with reference to FIG. 4.

The machine 200 can be operated under both a normal mode and a limp mode. When the machine 200 is operated under the normal mode, all of the cameras (or lenses) are utilized to generate the statue image. When an incident (e.g., a “lens blockage”) is detected, the machine 200 can then be operated under one of multiple limp modes, depending on which camera (or lens) is affected by the incident.

In some embodiments, for example, assuming that the camera module 207 includes a left grayscale lens, a right grayscale lens, and a color lens. In such embodiments, there can be at least three limp modes to select from, as shown in Table 1 below.

TABLE 1

| Cases | Incident Descriptions | Limp Modes // Models |
|---|---|---|
| 1 | Left and/or right lens is | [Limp Mode 1 // Model 1] Use model |
| | occluded by debris (color | trained on color lens only |
| | lens is clear) | |
| 2 | Color lens is occluded by | [Limp Mode 2 // Model 2] Use model |
| | debris (left and right | trained on the grayscale image from the |
| | lenses are clear) | left or right lens (and the disparity map |
| | | created using the left and right lenses) |
| 3 | Color lens + left or right | [Limp Mode 3 // Model 3] Use model |
| | lens occluded by dirt | trained only the left/right grayscale lens |

In Case 1, when the left lens or the right lens is blocked, Limp Mode 1 is selected and trained Model 1 is used to generate the status image. Model 1 is trained by images from the color lens only. With the trained Model 1, the status image can be generated based only on the input images from the color lens. In some embodiments, Model 1 can be trained, along with the images from the color lens, with images of either one of the left or right lenses.

In Case 2, when the color lens is blocked and the left and right lenses are clear, Limp Mode 2 is selected and trained Model 2 is used to generate the status image. Model 2 is trained by grayscale images from the left or right lens, as well as a disparity map (e.g., including depth information) created based on images from the left and right lenses.

In Case 3, when the color lens and one of the left and right lens are blocked, Limp Mode 3 is selected and trained Model 3 is used to generate the status image. Model 3 is trained by images from the grayscale images from the left and/or right lens. In some embodiments, Model 3 can be trained by images from both the grayscale images from the left and right lens (such that the relationships between the two sets of images can be determined). In some embodiments, Model 3 can be trained by images from the grayscale images from one of the left and right lens.

In other embodiments, there can be more than three lenses and therefore different combinations of images used for training the models. The foregoing cases are only examples and are not intended to limit the present technology.

Embodiments of these cameras and lenses are discussed in detail with reference to FIG. 3. FIG. 3 is a schematic diagram illustrating a camera module 300 of a machine in accordance with embodiments of the present technology. As shown, the camera module 300 includes a left lens 301 and a right lens 303 positioned on both sides, respectively. The camera module 300 also includes a color lens positioned between the left lens 301 and the right lens 303. In some embodiments, the color lens 305 can be positioned in various locations (e.g., close or at the center of the camera module 300).

FIG. 4 is a picture showing an image 400 captured by a camera module in accordance with embodiments of the present technology. The image 400 shows a status image of an excavator bucket of a machine during a normal mode operation. When there is an incident, the present system can generate a simulated status image similar to the image 400 such that the operator can continue the current task without interruption.

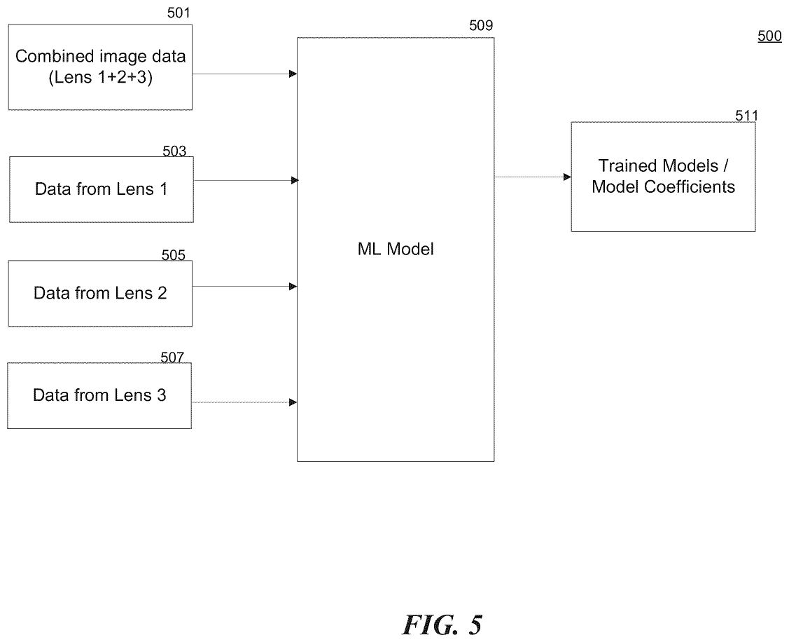

FIG. 5 is a schematic diagram illustrating a machine learning or training process 500 in accordance with embodiments of the present technology. The process 500 includes combined image data 501 from two or more lenses (e.g., color lens plus left lens; color lens plus right lens; right lens plus left lens; etc.) as input. Input also includes data from lens 1 (503), data from lens 2 (505), and data from lens 3 (507). The process 500 includes a machine learning model 509 to train the input data 501-507 and to generate multiple trained models 511 (e.g., Models 1-3 discussed above with reference to Table 1). In some embodiments, the trained models 511 include model coefficients which indicate the relationships among images captured from various lens and the status image for the operator to view. The process 500 further corresponds the trained models 511 with various limp modes (e.g., Limp Modes 1-3 discussed above with reference to Table 1) for future uses.

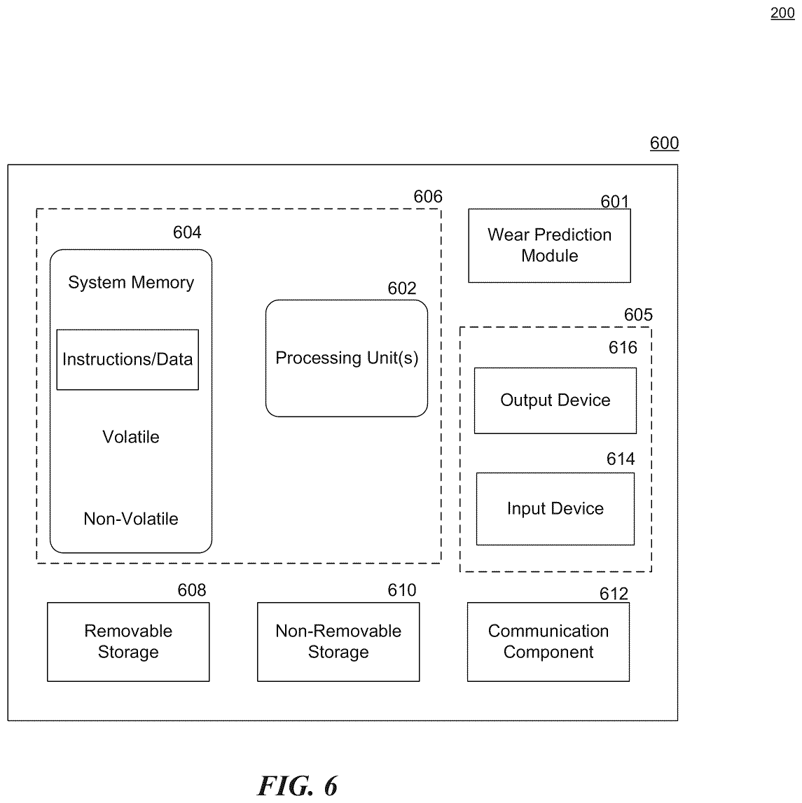

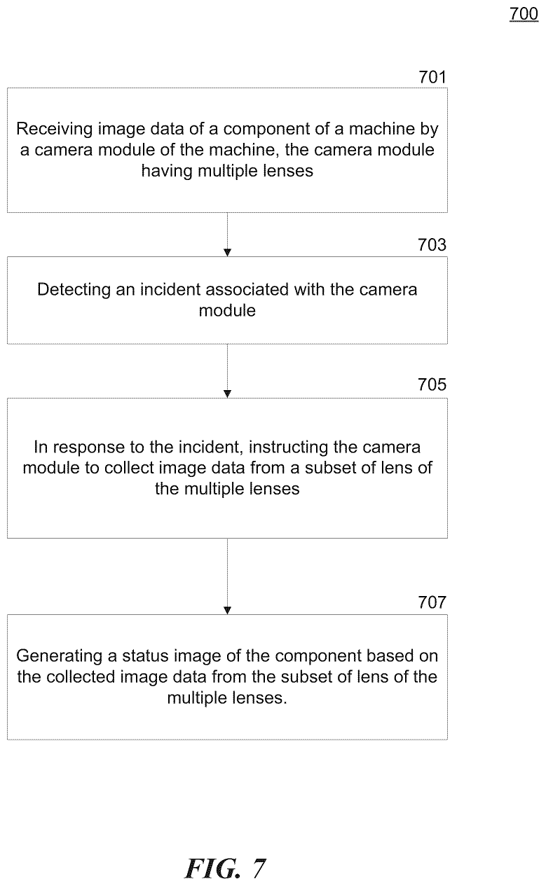

FIG. 6 is a schematic diagram illustrating components in a computing device 600 in accordance with embodiments of the present technology. The computing device 600 can be used to implement methods (e.g., FIG. 7) discussed herein. The computing device 600 can be used to perform the process discussed in FIG. 5. Note the computing device 600 is only an example of a suitable computing device and is not intended to suggest any limitation as to the scope of use or functionality. Other well-known computing systems, environments, and/or configurations that may be suitable for use include, but are not limited to, personal computers (PCs), server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, the computing device 600 includes at least one processing unit 602 and a memory 604. Depending on the exact configuration and the type of computing device, the memory 604 may be volatile (such as a random-access memory or RAM), non-volatile (such as a read-only memory or ROM, a flash memory, etc.), or some combination of the two. This basic configuration is illustrated in FIG. 6 by dashed line 606. Further, the computing device 600 may also include storage devices (a removable storage 608 and/or a non-removable storage 610) including, but not limited to, magnetic or optical disks or tape. Similarly, the computing device 600 can have an input device 614 such as keyboard, mouse, pen, voice input, etc. and/or an output device 616 such as a display, speakers, printer, etc. Also included in the computing device 600 can be one or more communication components 612, such as components for connecting via a local area network (LAN), a wide area network (WAN), cellular telecommunication (e.g. 3G, 4G, 5G, etc.), point to point, any other suitable interface, etc.

The computing device 600 can include a wear prediction module 601 configured to implement methods for operating the machines based on one or more sets of parameters corresponding to components of the machines in various situations and scenarios. For example, the wear prediction module 601 can be configured to implement the wear prediction process discussed herein. In some embodiments, the wear prediction module 601 can be in form of tangibly-stored instructions, software, firmware, as well as a tangible device. In some embodiments, the output device 616 and the input device 614 can be implemented as the integrated user interface 605. The integrated user interface 605 is configured to visually present information associated with inputs and outputs of the machines.

The computing device 600 includes at least some form of computer readable media. The computer readable media can be any available media that can be accessed by the processing unit 602. By way of example, the computer readable media can include computer storage media and communication media. The computer storage media can include volatile and nonvolatile, removable and non-removable media (e.g., removable storage 608 and non-removable storage 610) implemented in any method or technology for storage of information such as computer readable instructions, data structures, program modules or other data. The computer storage media can include, an RAM, an ROM, an electrically erasable programmable read-only memory (EEPROM), a flash memory or other suitable memory, a CD-ROM, digital versatile disks (DVD) or other optical storage, magnetic cassettes, magnetic tape, magnetic disk storage or other magnetic storage devices, or any other tangible medium which can be used to store the desired information.

The computing device 600 includes communication media or component 612, including non-transitory computer readable instructions, data structures, program modules, or other data. The computer readable instructions can be transported in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media can include wired media such as a wired network or direct-wired connection, and wireless media such as acoustic, radio frequency (RF), infrared and other wireless media. Combinations of the any of the above should also be included within the scope of the computer readable media.

The computing device 600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

FIG. 7 is a flow diagram showing a method 700 in accordance with embodiments of the present technology. The method 700 can be implemented to operating a machine. The method 700 starts at block 701 by receiving image data (e.g., FIG. 4) of a component of the machine by a camera module of the machine. The camera module can have multiple camera components (e.g., FIG. 3).

In some embodiments, the multiple camera components include a left grayscale lens, a left grayscale lens, and a color lens positioned between the left and right grayscale lens. In some embodiments, the multiple camera components include a depth sensor, an infrared sensor, etc.

At block 703, the method 700 continues by detecting an incident associated with the camera module. In some embodiments, the incident associated with the camera module can include a view obstruction of at least one of the multiple camera components of the camera module. In some embodiments, incident associated with the camera module can include a malfunction or a dysfunction of at least one of the multiple camera components of the camera module.

At block 705, the method 700 continues by in response to the incident, instructing the camera module to collect image data from a subset (e.g., Table 1) of the multiple camera components. The subset of the multiple camera components can include only a color lens. In some embodiments, the subset of the multiple camera components includes a color lens and a grayscale lens.

In some embodiments, the subset of the multiple camera components can include a left grayscale lens and a right grayscale lens. In such embodiments, the method 700 can further include (i) generating a disparity map based on the collected image data of the subset of the multiple camera components; and (ii) generating the status image of the component at least based on the disparity map.

At block 707, the method 700 continues by generating a status image of the component based on the collected image data from the subset of the multiple camera components. In some embodiments, the method 700 can further include generating the status image of the component at based on a trained model with coefficients indicating relationships among data collected via the multiple camera components.

In some embodiments, the method 700 can further include, in response to the incident, instructing the machine to switch from a normal mode to a limp mode selected from multiple candidate limp modes. In some embodiments, each of the limp mode corresponds to a trained model, and the trained model includes coefficients indicating relationships among data collected via the multiple camera components.

Another aspect of the present method includes a method for generating a status image of a component of a machine. The method can include: (i) collecting image data of a component of the machine by a camera module of the machine, the camera module having multiple camera components; (ii) analyzing the collected image data of the component so as to identify coefficients indicating relationships among data collected via the multiple camera components; and (iii) generating multiple trained models corresponding to multiple limp modes, wherein each of the limp modes corresponding to an incident associated with at least one of the multiple camera components of the camera module.

### INDUSTRIAL APPLICABILITY

The systems and methods described herein can effectively manage a component of a machine by generating reliable status images of the component under a limp mode (e.g., when there is an incident such as lens blockage or view obstruct) and a normal mode. The methods enable an operator, experienced or inexperienced, to effectively manage and maintain the component of machine under the limp mode without interrupting the ongoing tasks of the machine. The present systems and methods can also be implemented to manage multiple industrial machines, vehicles and/or other suitable devices such as excavators, etc.

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” (or the like) in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the claims are not to be limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

As used herein, the term “and/or” when used in the phrase “A and/or B” means “A, or B, or both A and B.” A similar manner of interpretation applies to the term “and/or” when used in a list of more than two terms.

The above detailed description of embodiments of the technology are not intended to be exhaustive or to limit the technology to the precise forms disclosed above. Although specific embodiments of, and examples for, the technology are described above for illustrative purposes, various equivalent modifications are possible within the scope of the technology as those skilled in the relevant art will recognize. For example, although steps are presented in a given order, alternative embodiments may perform steps in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. Additionally, the term “comprising” is used throughout to mean including at least the recited feature(s) such that any greater number of the same feature and/or additional types of other features are not precluded, unless context suggests otherwise. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein. Any listing of features in the claims should not be construed as a Markush grouping.

1. A method for operating a machine, comprising:
receiving image data of a component of the machine by a camera module of the machine, the camera module having multiple camera components;
detecting an incident associated with the camera module;
in response to the incident, instructing the camera module to collect image data from a subset of the multiple camera components; and
generating a status image of the component based on the collected image data from the subset of the multiple camera components.

2. The method of claim 1, wherein the multiple camera components include a left grayscale lens, a left grayscale lens, and a color lens positioned between the left and right grayscale lens.

3. The method of claim 1, wherein the multiple camera components include a depth sensor.

4. The method of claim 1, wherein the multiple camera components include an infrared sensor.

5. The method of claim 1, wherein the incident associated with the camera module includes a view obstruction of at least one of the multiple camera components of the camera module.

6. The method of claim 1, wherein incident associated with the camera module includes a malfunction or a dysfunction of at least one of the multiple camera components of the camera module.

7. The method of claim 1, wherein the subset of the multiple camera components includes a color lens and a grayscale lens.

8. The method of claim 1, wherein the subset of the multiple camera components includes a left grayscale lens and a right grayscale lens.

9. The method of claim 8, further comprising:
generating a disparity map based on the collected image data of the subset of the multiple camera components; and
generating the status image of the component at least based on the disparity map.

10. The method of claim 1, wherein the subset of the multiple camera components includes a color lens.

11. The method of claim 1, further comprising:
generating the status image of the component at based on a trained model with coefficients indicating relationships among data collected via the multiple camera components.

12. The method of claim 1, further comprising:
in response to the incident, instructing the machine to switch from a normal mode to a limp mode selected from multiple candidate limp modes.

13. The method of claim 1, wherein each of the limp mode corresponds to a trained model, and wherein the trained model includes coefficients indicating relationships among data collected via the multiple camera components.

14. The method of claim 1, wherein the component of the machine includes an excavator bucket.

15. A system comprising:
a processor;
a memory communicably coupled to the processor, the memory comprising computer executable instructions that, when executed by the processor, cause the system to:
receive image data of a component of the machine by a camera module of the machine, the camera module having multiple camera components;
detect an incident associated with the camera module;
in response to the incident, instruct the camera module to collect image data from a subset of the multiple camera components; and
generate a status image of the component based on the collected image data from the subset of the multiple camera components.

16. The system of claim 15, the multiple camera components include a left grayscale lens, a left grayscale lens, and a color lens positioned between the left and right grayscale lens.

17. The system of 15, wherein the incident associated with the camera module includes a view obstruction of at least one of the multiple camera components of the camera module.

18. The system of 15, wherein the subset of the multiple camera components includes a color lens or a grayscale lens.

19. The system of 16, wherein the subset of the multiple camera components includes a left grayscale lens and a right grayscale lens, and wherein a disparity map is generated based on the collected image data of the subset of the multiple camera components, and wherein the status image of the component is generated at least based on the disparity map.

20. A method for generating a status image of a component of a machine, comprising:
collecting image data of a component of the machine by a camera module of the machine, the camera module having multiple camera components;
analyzing the collected image data of the component so as to identify coefficients indicating relationships among data collected via the multiple camera components; and
generating multiple trained models corresponding to multiple limp modes, wherein each of the limp modes corresponding to an incident associated with at least one of the multiple camera components of the camera module.
